(19) United States
(12) Patent Application Publication
(10) Pub. No.: US 2007/0119562 A1
(43) Pub. Date: May 31, 2007

(54) System and method for termination of a wire rope

(76) Inventors: George Robert Gregory, Flint, TX (US); Robert Love, Mansfield, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 11/472,605

(22) Filed: Jun. 22, 2006

Related U.S. Application Data
(63) Continuation-in-part of application No. 11/016,940, filed on Dec. 2, 2004.
Application No. 11/016,940 is a continuation-in-part of application No. 10/825,658, filed on Apr. 14, 2004.

(51) Int. Cl. B23K 23/00; B22D 19/00

(52) U.S. Cl. 164/54; 249/86; 228/234.3

(57) ABSTRACT

The invention disclosed herein provides a drag socket comprising a frame, a first attachment means for connecting the frame to a control line, a second attachment means for connecting the frame to a drag line, a socket body removably attached to the frame, a releasing wedge releasably inserted into the socket body, a locking wedge releasably inserted into the releasing wedge, a wire rope termination fused to a wire rope adjacent the locking wedge, and a load plate movably attached to the frame adjacent the releasing wedge whereby the releasing wedge is retained in the socket body when a force is applied to the wire rope. The invention also discloses a process of forming a drag socket attached to a wire rope comprising the steps of providing a drag socket frame, inserting the wire rope into a socket body in the drag socket frame, forming a termination on the wire rope, applying a releasing wedge to the wire rope and placing it into the socket body, applying a locking wedge to the wire rope and placing it into the releasing wedge, applying a load plate adjacent the socket body in a position to resist forces from the releasing wedge, and applying tension to the wire rope to move the termination to compress the locking wedge and the releasing wedge. Additionally, the invention discloses a process of releasing a drag socket from a wire rope comprising the steps of providing a drag socket frame, providing a termination on the wire rope, providing a locking wedge adjacent the termination, providing a releasing wedge around the locking wedge, providing a socket body, secured in the socket frame around the releasing wedge, providing a load plate adjacent the releasing wedge and removably secured within the frame, providing a retaining means for applying pressure to the load plate and the frame, and removing the retaining means whereby pressure on the load plate is released and the releasing wedge is released.

### CROSS-REFERENCE TO RELATED APPLICATIONS

This application is a continuation-in-part of U.S. patent application Ser. No. 11/016,940 entitled “System and Method for Termination of a Wire Rope” filed Dec. 2, 2004, which is a continuation-in-part of U.S. patent application Ser. No. 10/825,658 entitled “Method for Making a Termination for a Wire Rope for Mining Equipment” filed Apr. 14, 2004.

### FIELD OF THE INVENTION

The present invention relates to an apparatus and method for terminating a wire rope and connecting it to various pieces of equipment. In a preferred embodiment, the termination is used in association with a dump bucket or socket in the field of mining.

### BACKGROUND OF THE INVENTION

This invention relates to clamping devices for cables and particularly to an improved open wedge socket for clamping the cable and facilitating release of the cable from the socket.

Open wedge sockets are typically used with cranes or other hoisting machines. The socket is attached to the free end of a cable that is suspended from the crane. The socket provides means for coupling the free end of the cable to buckets or other apparatus which are then lifted or transported by the crane.

Conventional open wedge sockets include a wedge member and a socket for receiving the wedge member. A cable is captured in the socket by passing the free end of the cable through the socket, laying the wedge on the cable, and returning the free end of the cable over the wedge and back through the socket. The cable bearing wedge is then driven into the socket with sufficient force to trap the cable and wedge within the socket. Examples of these conventional open wedge sockets are shown in U.S. Pat. Nos. 1,355,004; 1,745,449; 2,217,042; 2,372,754; 2,482,231; 3,654,672; and 3,957,237.

A slightly different example of a conventional open wedge socket is shown in Great Britain Patent No. 2,080,389. In this example, there are two wedge sections, one stationary and integral with the socket and the other movable into the socket to grip a cord. The cord is laid in the socket over the stationary wedge section and the moveable section is forced into the socket. This socket has the same problems as the other conventional sockets discussed above.

It is often necessary to release the cable from the wedge socket. In the conventional wedge sockets, the wedge must be driven out of the socket and the free end of the cable must be pulled back into and through the socket. The free end of the socket frequently becomes kinked or frayed during normal use of the wedge socket. A slight kink or fray can effectively prevent a user from driving the wedge out of the socket. Further, the damaged free end will not pass back through the conventional socket. Heretofore, the only solution to this problem has been to cut the damaged cable to remove the frayed or kinked end.

An example of a known open wedge socket is shown in U.S. Pat. No. 4,602,891 to McBride. McBride provides an open wedge socket for a cable that includes a wedge having a peripheral surface for engaging the cable, a housing including an outwardly opening channel for receiving the wedging cable, and an interference member having a sliding fit on the housing to capture the wedge and the cable in the channel. However, the McBride invention allows for a whip-like backlash from the frayed end of the cable when the interference member is removed.

Removal of the captured cable and wedge from a conventional wedge socket can also be hampered by the buried nature of the wedge itself. Because of the weight that is repeatedly carried on the socket during lifting operations, the wedge is typically forced into the socket so tightly that it is necessary to remove the wedge with a sledgehammer. The wedge is generally contained or buried within the socket so that it is unreachable by the head of the sledgehammer. Heavy-duty punches or levers may be required to enable the sledgehammer to reach and strike a buried wedge.

Removal of the wedge and cable in the manner described above is a cumbersome, labor intensive, time-consuming exercise and many times results in destruction of the cable. In some cases hydraulic hammers are used to dislodge the cable. The hammers create flying chips of metal and can cause serious injury. In other cases, the stored energy in the loop of the wire rope over the wedge is tremendous. Release of this energy as the rope is removed can cause severe injury. In some cases, the removal of prior art commercial systems has resulted in death. Because of the time, labor and danger involved, the wedge and cable removal process associated with conventional wedge sockets is also very costly, resulting in extended periods of equipment downtime and inefficient use of personnel.

A need has existed for a wire rope termination made by a fast process resulting in a light-weight, heavy duty termination. A further need has existed for connecting wire rope terminations to mining and other equipment quickly and safely. A further need has existed for a method to create wire rope terminations which result in great strength. The present invention meets these needs.

The wire rope terminations of the present invention also relate to the field of exothermic metallic reactions known as thermite reactions.

Thermite reactions are highly exothermic reactions. During such reactions initially solid reactants undergo oxidation and reduction processes which liberate great heat from the reaction products. Such thermite reaction processes serve various useful purposes. Important applications of the thermite reaction process include the welding of metallic members and the cast forming of metal or ceramic parts. In such applications the thermite reaction is utilized to produce a superheated molten metal to cast a part or produce a weld metal for the welding and joining of the members.

Thermite reactions are generally described as reactions between metal oxides and metallic reducing agents. The metal oxides chosen for the reaction are those which have low heats of formation. The reducing agents chosen for the reaction are those which exhibit oxide species with high heats of formation. The difference in the heat of formation of the reaction product metal oxide and the reactant metal oxide is the heat produced in the reaction, and, as indicated, such reactions are highly exothermic. Thermite reactions of particular interest due to their extensive industrial usage are as follows:

| | | Heat Evolved |
|---|---|---|
| | Thermite Reactions | K cal |
| (1) | 3Fe₃O₄ + 8A1 = 9Fe + 4Al₂O₃ | 719 |
| (2) | 3FeO + 2Al = 3Fe + Al₂O₃ | 187 |
| (3) | Fe₂O₃ + 2Al = 2Fe + Al₂O₃ | 181 |
| (4) | 3CuO + 2Al = 3Cu + Al₂O₃ | 275 |
| (5) | 3Cu₂O + 2Al = 6Cu + Al₂O₃ | 260 |

In present commercial form the thermite reactions noted above all require local temperatures of approximately 1750° F. in order to be self-propagating (i.e., in order to ignite and continue the reaction to completion). For this reason, starting materials of lower ignition temperatures (about 850° F.) are placed in direct contact with the thermite reaction materials. Such starting materials may be conveniently ignited with a flint igniter, or other like sparking or ignition device. Upon ignition of the starting material, the starting material serves to ignite the higher temperature ignition point thermite reaction materials.

After the termite reaction is complete, liquid metal from the crucible passes into a chamber or mold where it is solidified for use.

A conventional thermite reaction is shown U.S. Pat. No. 4,881,677 to Amos. Amos shows a thermite reaction containment vessel on method of using it which includes a crucible in which the exothermic material is contained and which is connected at its lower end via tap hold to a well chamber in which parts are welded together.

Accordingly, it is one desired aspect of the invention to combine the products of the thermite reaction to create a wire rope termination to be used in combination with a novel connector mechanism to provide an extremely high connection strength along with a mining wire rope connector that is extremely safe and easy to use.

### SUMMARY

The invention disclosed herein provides a drag socket comprising a frame, a first attachment means for connecting the frame to a control line, a second attachment means for connecting the frame to a drag line, a socket body removably attached to the frame, a releasing wedge releasably inserted into the socket body, a locking wedge releasably inserted into the releasing wedge, a wire rope termination fused to a wire rope adjacent the locking wedge, and a load plate movably attached to the frame adjacent the releasing wedge whereby the releasing wedge is retained in the socket body when a force is applied to the wire rope.

The invention also discloses a process of forming a drag socket attached to a wire rope comprising the steps of providing a drag socket frame, inserting the wire rope into a socket body in the drag socket frame, forming a termination on the wire rope, applying a releasing wedge to the wire rope and placing it into the socket body, applying a locking wedge to the wire rope and placing it into the releasing wedge, applying a load plate adjacent the socket body in a position to resist forces from the releasing wedge, and applying tension to the wire rope to move the termination to compress the locking wedge and the releasing wedge.

Additionally, the invention discloses a process of releasing a drag socket from a wire rope comprising the steps of providing a drag socket frame, providing a termination on the wire rope, providing a locking wedge adjacent the termination, providing a releasing wedge around the locking wedge, providing a socket body, secured in the socket frame around the releasing wedge, providing a load plate adjacent the releasing wedge and removably secured within the frame, providing a retaining means for applying pressure to the load plate and the frame, and removing the retaining means whereby pressure on the load plate is released and the releasing wedge is released.

The invention also discloses an apparatus for connecting a drag line to a drag chain comprising a drag line termination means, fused to the end of the drag line for rigidly expanding the diameter of the drag line, a connector frame attached to the drag chain and to a lift line, and a receiving means within the connector frame, abutting the drag line termination means, for compressing the drag line termination means to resist a force applied to the drag line.

### BRIEF DESCRIPTION OF THE DRAWINGS

In the detailed description of the preferred embodiments presented below, reference is made to the accompanying drawings.

FIG. 1 depicts an exploded isometric view of the apparatus used in the method for making a termination for a wire rope using an exothermic metallic material.

FIG. 2 depicts an isometric view of the apparatus used in the method.

FIG. 3 depicts a front view of the assembled apparatus used in the method.

FIG. 4 depicts a cross-sectional side view of the assembled apparatus used in the method.

FIG. 5 depicts a perspective view of a socket usable with the termination.

FIG. 6a is a cutaway plan view of an alternate embodiment of a socket usable with the termination.

FIG. 6b depicts a side view of an alternate embodiment of a socket usable with the termination.

FIG. 7 depicts an isometric view of an alternate embodiment of a socket usable with the termination.

FIG. 8a depicts a side view of two frustroconical wedges usable with the socket of the present invention.

FIG. 8b depicts a plan view of three frustroconical wedges used with the termination of the present invention.

FIG. 9a depicts an isometric assembly view of a wire rope, termination, several frustroconical wedges and a socket.

FIG. 9b represents an isometric partially assembled assembly view of a wire rope, termination, several frustroconical wedges and a socket.

FIG. 9c represents an isometric partially assembled view of a termination, socket and wire rope.

FIG. 10 shows an isometric view of an alternate embodiment of the invention.

FIG. 11 shows a section plane view of an alternate embodiment of the invention.

FIG. 12 shows a diagram of a mining system employing the connector systems of the invention.

### DETAILED DESCRIPTION OF THE PREFERRED EMBODIMENTS

Before explaining the present embodiments in detail, it is to be understood that the embodiments are not limited to the particular descriptions and that the embodiments can be practiced or carried out in various ways.

The termination described herein is made by a labor saving process for use with mining equipment. The termination for wire rope is lighter than conventional terminations used on drag lines in the mining industry, but has the same or greater strength.

The terminations for wire rope for the mining industry must be capable of sustaining a large break force. The termination of the present invention weighs appreciably less than similarly sized wire ropes with typical terminations, up to or exceeding 50% less. For example, a current style termination could weigh 6000 pounds for a 4⅜ inch diameter wire rope. In contrast certain embodiments of the invention utilize a termination weighing only about 1500-2800 pounds for the same diameter wire rope.

In the preferred embodiment, the terminations are for use with wire ropes with a diameter between ¼ inches and 7 inches. The terminations will work equally well with smaller and larger diameter wire rope. Typical wire ropes are made of steel, alloys of steel and combinations thereof. The wire rope can be a single strand rope or a multi-strand rope.

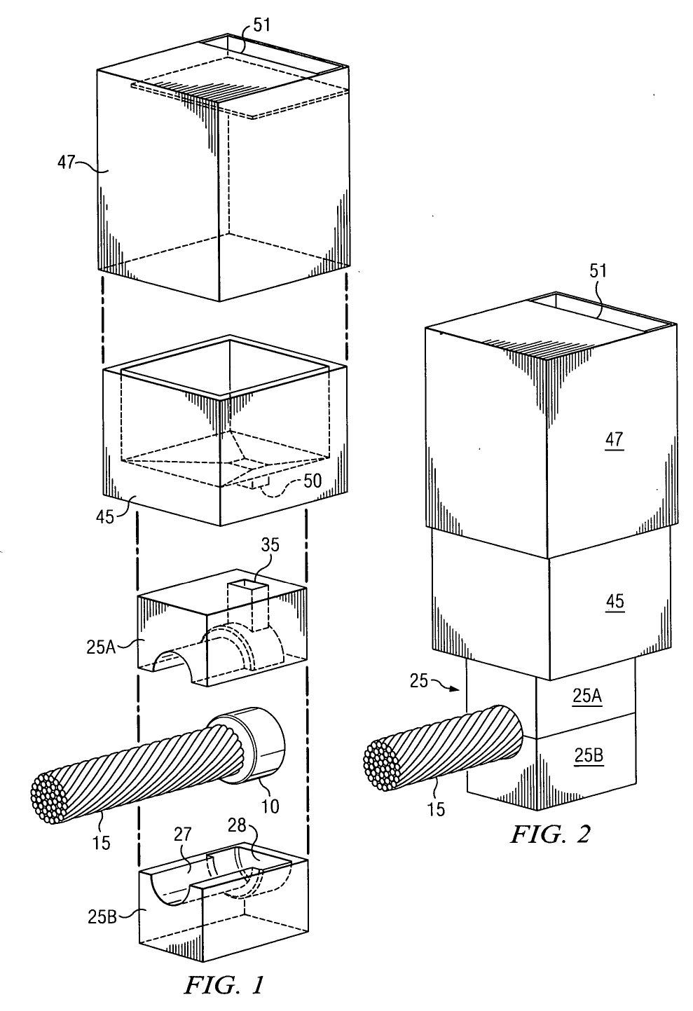

The terminations are made using the equipment of FIG. 1. In a first embodiment, the termination 10 is formed on the end of a wire rope 15 using an exothermic metallic material. In an alternative embodiment, a liquid adhesive can be used to make the termination for the wire rope. The termination formed from the liquid adhesive has additional safety advantages as the termination can be made without heat in the field, preventing burns to workers, which is a much needed benefit.

For terminations made using the exothermic metallic material, one end of the wire rope is inserted into a mold 25. FIG. 1 depicts the mold 25 as a two part mold with a top part 25a and a bottom part 25b, but a one piece mold can also be used. For large diameter wire ropes, a three piece mold may be used. In this embodiment, the top half of the mold is segmented along the axis of the wire rope opening 27. For extremely large diameter ropes, a several piece mold may be used.

The pieces of mold 25 are held together with toggle-type latches (not shown) spaced around the periphery of the mold. In the preferred embodiment, using two pieces for the mold, there are four latches, two on each side. For the preferred embodiment where the mold is made in three pieces, six latches are used, two on each side and two on the top to hold the top two pieces of the top section of the mold together. The latches are placed so that leakage of molten metal between the seams of the pieces of the mold and down the access of the wire rope is minimized or preferably prevented.

The mold has a mold opening 35. The mold opening can be rectangular, but an elliptical shape or round shape or other shape can be used. The opening should have a diameter that is adequate to permit molten metal to flow into the mold.

The mold has a cavity formed with two connected chambers, a wire rope opening 27 and a termination cavity 28. Wire rope opening 27 is cylindrical and formed to the diameter of the wire rope. Termination cavity 28 in the preferred embodiment is also cylindrical having a diameter approximately two inches greater than the diameter of wire rope 15. The dimensions of the termination cavity are a matter of design choice. In the preferred embodiment of a termination cavity for a 4½-inch diameter wire rope, the cavity is 7¾ inches in diameter and 4 inches long

The termination cavity can have a conical, cylindrical, or even rectangular shape. The cavity dictates the resultant shape of the termination. For example, the termination can include a hole perpendicular to the axis of the wire rope form or form a particular shape for connection to other equipment dependent on the shape of the termination cavity.

The external shape of the mold can be any functional shape but is preferably rectangular. The overall external dimensions of the mold of a preferred embodiment are between about 6 inches and about 20 inches; 10 inches is a preferred example. The width of the mold of a preferred embodiment can range from about 6 to about 16 inches; 8 inches is a preferred example. The length of a preferred embodiment can range from about 8 to about 24 inches; 12 inches is a preferred example.

The mold is preferably made of graphite or other materials that are very heat resistant. Another embodiment uses a sand casting mold as known in the art.

FIG. 2 shows an isometric view of wire rope 15 inserted into mold 25. FIG. 2 also shows a crucible 45, baffle 47 and baffle opening 51.

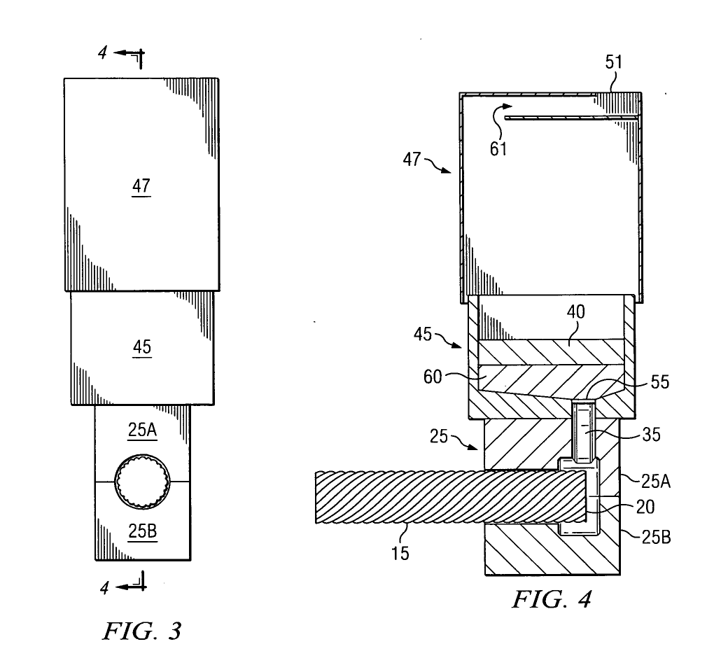

FIG. 3 shows a front view of the crucible 45 with the mold 25 and a preferable circular opening for engaging the wire rope.

FIG. 4 depicts a cross-sectional view of the mold, crucible and wire rope.

The crucible provides a reaction chamber for the exothermic material. The crucible dimensions preferably coincide with or are slightly larger than the dimensions of the mold. The dimensions of the crucible of a preferred embodiment are between 10 and 18 inches in height (preferably 12 inches), between 10 and 20 inches in width (preferably 14.5 inches), and between 10 and 30 inches in length (preferably 15 inches). In the preferred embodiment, the walls of the crucible are one inch thick. The floor of the crucible is angled to assist the molten metal flowing out of the crucible through crucible opening 50. The crucible can have a cylindrical shape, a rectangular shape, but generally it is hollow to receive material. The crucible opening has a shape that can be rectangular, ellipsoid, or another usable shape for flowing molten metal into the crucible. The crucible is preferably made of graphite or a heat resistant material that will not deform in the presence of high heat.

A separator 55 is disposed over the crucible opening 50. The purpose of the separator is to keep the exothermic metallic material separate from the mold until ignition of the exothermic metallic material. Typically, separator 55 is a mild steel material; however, any sacrificial material can be used. In a preferred embodiment, the separator has a width between 2 inches and 6 inches in width and a length between 4 inches and 8 inches with a thickness that can range in a corresponding manner. In a preferred embodiment, the thickness of the separator is 10 gauge.

The terminations are made using an exothermic metallic material 40 that is placed into the crucible. The exothermic metallic material is preferably a powdered metallic material. Different sizes of granules, powder or small metal chips can be used in the same crucible. In the preferred embodiment, the material is provided in two phases. The first phase has a fine granularity to promote ease of ignition. The second phase has a coarse granularity to slow burning of the material and provide for adequate bulk to sustain the reaction. In the preferred embodiment, the first phase has granules of approximately 1/100 of an inch in diameter and the second phase granules have the size of approximately 1/10 an inch in diameter. In the preferred embodiment, the exothermic metallic material is sold under the trademark “Cad Weld”, available from ERICO, Inc. of Solom, Ohio.

The exothermic reactions utilized in the invention include but are not limited to the following:

| | | Heat Evolved |
|---|---|---|
| | Thermite Reactions | K cal |
| (1) | 3Fe₃O₄ + 8Al = 9Fe + 4Al₂O₃ | 719 |
| (2) | 3FeO + 2Al = 3Fe + Al₂O₃ | 187 |
| (3) | Fe₂O₃ + 2Al = 2Fe + Al₂O₃ | 181 |
| (4) | 3CuO + 2Al = 3Cu + Al₂O₃ | 275 |
| (5) | 3Cu₂O + 2Al = 6Cu + Al₂O₃ | 260 |

A baffle 47 is inserted over the crucible 45 to contain the heat and direct any resulting vapors out a baffle opening 51. The baffle is preferably the same of similar shape to that of the crucible. The baffle is preferably made from steel plate. As shown in FIG. 4, the baffle 47 has at least one internal baffle 61 for deflecting the heat and hot reaction gasses from the crucible.

In a preferred embodiment, the baffle can have a length ranging between 11 inches to 31 inches, a width ranging between 11 inches to 21 inches, and a height ranging between 11 inches to 19 inches in length. The preferred dimensions are 16 inches in length, 15 inches in width, and 18 inches in height. The preferred thickness of the baffle is 10 gauge.

The process of making a termination in the preferred embodiment begins by clamping the mold together by closing the appropriate toggle clamps. Crucible 45 and baffle 47 are then appropriately assembled. Assembly requires insertion of separator 55 in between crucible 45 and termination cavity 28. Crucible 45 and mold 28 must be positioned so that ducted communication, through separator 55 is achieved.

In the preferred embodiment, the end of wire rope 20 is cleaned before the termination is formed. The cleaning step can be performed by any normal means of cleaning a substance. The preferred methods for cleaning are either by using a torch, by using chemicals to remove dirt, and combinations thereof.

After cleaning, wire rope 15 is inserted into wire rope opening 27 far enough to extend into termination cavity 28. In the preferred embodiment of the method, the wire rope is extended approximately two thirds of the width of termination cavity 28.

Exothermic metallic material 40 is then added to crucible 45 in at least one phase. When additional phases of exothermic metallic material 40 are desired in crucible 45, the bulk phases are added first and allowed to settle. The fine phases are then added and allowed to settle.

The exothermic metallic material 40 is kindled in the crucible 45. The exothermic metallic material 40 can be kindled using a striker, a torch, a flame, or other similar heat sources, and combinations thereof. Once kindled, the exothermic metallic material 40 burns quickly. The exothermic metallic material forms a ductile and malleable material and liquefies the separator 55 forming a molten material 60.

Molten material 60 flows into mold 25 through mold opening 35 and comes into contact with end 20 of wire rope 15. Molten material 60 is of such a temperature that is partially melts and fuses to the wire rope. Molten material 60 takes the form of mold 25 around end 20 forming termination 10.

Molten material 60 is allowed to cool which in the preferred embodiment can take approximately 15 minutes. Crucible 45 and baffle 47 are then removed from mold 25. Mold 25 is then separated into pieces by disconnecting the latches which hold the pieces of the mold together. If the mold is a single piece, it may need to be broken away from the termination. In cooling, exothermic material 60 slightly contracts, allowing the pieces of the mold to be removed easily.

The resultant termination 10 is lighter than conventional terminations and is typically capable of sustaining a higher break force than the wire rope.

A termination according to the present invention may be made using a liquid adhesive. If the termination is formed using a liquid adhesive, the wire rope first end is place in a mold. A liquid adhesive is then poured into the mold 25 through the mold opening 35 covering the end of the wire rope. The liquid adhesive may need to be heated to room temperature if the method is performed in a cold climate. Examples of usable liquid adhesives include an epoxy, such as a Devcon™ aluminum epoxies from Illinois Tool Work, of Devcon, Ill. Epoxies from 3-M of Minneapolis, Minn. are also contemplated as usable herein, as well as other epoxies that are strong and bond to steel.

The liquid adhesive is allowed to cure in the mold 25 forming a cured termination typically capable of sustaining a higher break force than the wire rope.

In the preferred embodiment the formed termination is inserted into a socket. The socket has an equipment connector on one end adapted to engage mining equipment and a wire rope connector on the other end adapted to engage the termination.

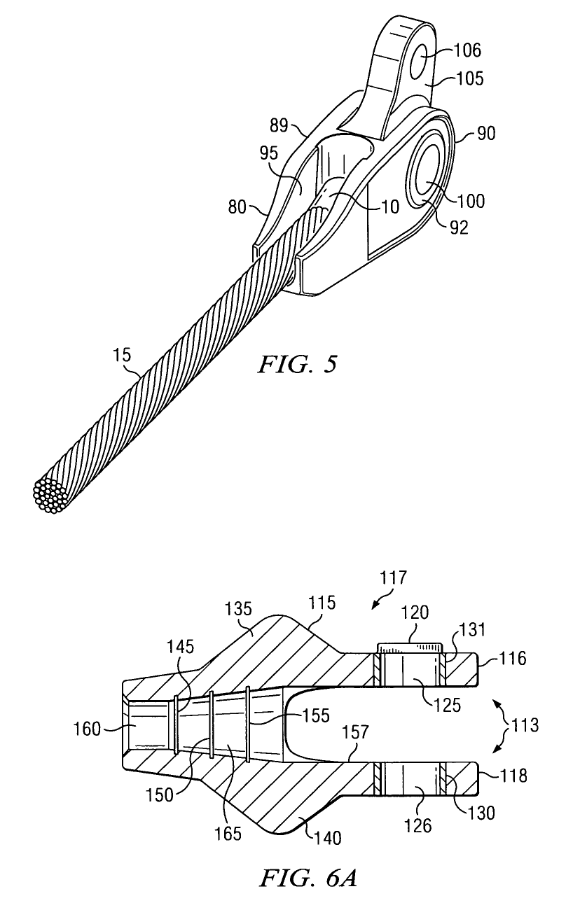

FIG. 5 shows the wire rope with termination engaging a socket 89. The socket has a first connector end 90 adapted to engage mining equipment; and a second connector end 80 to engage the termination 10 on wire rope 15. First connector end 90 includes hole 92, connector 105 and connector hole 106. Hole 92 is sized to include a bushing 100 for connection to mining equipment. Connector hole 106 is similarly sized for connection to the mining equipment. Second connector end 80 includes an upward facing opening 95 which is sized to permit an insertion of wire rope 15 and termination 10.

Socket 89 is preferably formed from ANSI 4140 steel or EN30B material. The dimensions of socket 89 are a matter of engineering choice. However, in the preferred embodiment for a wire rope of 4½ inch diameter, socket 117 is approximately 35 inches long and 13¼ inches wide.

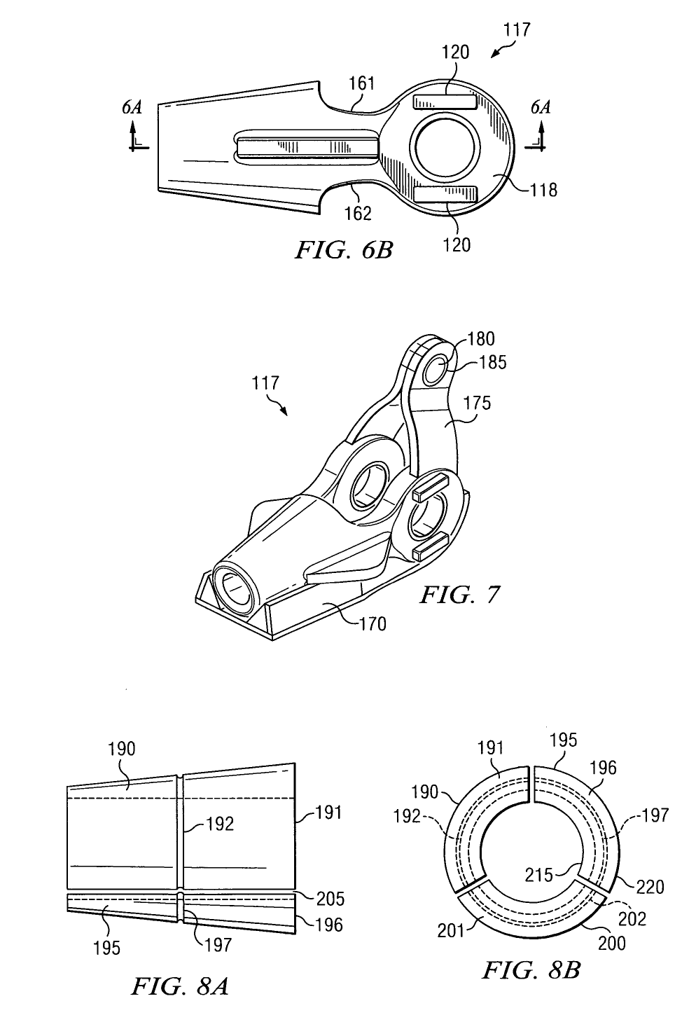

Moving to FIGS. 6a and 6b, a second preferred embodiment of a socket is shown as socket 117. Socket 117 has body 115. In the preferred embodiment, body 115 is formed from ANSI 4140 steel or EN30B material. First connector end 113 comprises socket ear 116 and socket ear 118 which are used for connection to mining equipment. Socket ear 116 includes hole 125. Similarly, socket ear 118 includes hole 130. Copper alloy bushing 131 is placed in hole 125. Similarly, copper alloy bushing 130 is placed in hole 126. The size and composition of the bushings are a matter of engineering choice.

Body 115 includes ear support 135 and ear support 140. Ear support 135 and ear support 140 strengthen body 115 to prevent spreading of the ears during operation. Guide set 120 is used during operation of the mining equipment to locate a connector (not shown) during operation. The inclusion of the ear supports and guide set are optional depending on the forces applied to the system and connection pins used in operation.

Body 115 includes a bore 160 opening into frustroconical bore 165. Bore 160 is approximately the same diameter as wire rope 15. Frustroconical bore 165 includes circumferential slots 145, 150 and 155. The circumferential slots allow for lubrication of the frustroconical wedges (not yet shown). The inclusion of the circumferential slots is optional.

Body 115 further includes lateral opening 157. Lateral opening 157 is sized to allow entry and exit of the termination.

FIG. 6b shows cradles 161 and 162 formed in body 115 of socket 117. The cradles are provided in the preferred embodiment to reduce weight and are optional.

FIG. 7 shows an alternate embodiment of the socket for the termination, socket 118. Socket 118 includes upward connector 175 for connection to mining equipment. Upward connector 175 includes through hole 180 and bushing 185. Socket 118 also includes sled 170. In the preferred embodiment, sled 170 is welded to socket 118 to protect the socket and its internal pieces from the elements during mining operations.

FIGS. 8a and 8b show frustroconical wedges 190, 195 and 200. The frustroconical wedges are designed to fit into frustroconical bore 165 and around wire rope 15. Frustroconical wedge 190 includes surface slot 192. Similarly, frustroconical wedge 195 includes surface slot 197 and frustroconical wedge 200 includes surface slot 202. The surface slots are provided to allow a circular retaining tie to be applied to the frustroconical wedges to hold them together around wire rope 15 during insertion into frustroconical bore 165.

In the preferred embodiment, of frustroconical wedges for use with a 4½ inch wire rope, each frustroconical wedge is 8⅝ inches long and has an outer diameter of 5⅞ inches and in inner diameter of 3⅛ inches. Frustroconical wedge 190 also includes mating surface 191, similarly, frustroconical wedge 191 has mating surface 196 and frustroconical wedge 200 has mating surface 201. Each of the mating surfaces is flat and is designed to contact a flat mating surface of the termination during operation of the invention. Frustroconical wedges 190, 195 and 200 when assembled form an interior bore 215 and an exterior surface 220. The interior bore is cylindrical. The exterior surface is frustroconical.

FIG. 8b shows that the three frustroconical wedges of the preferred embodiment are equal in size, being separated by gaps at 120 degrees. For example, gap 205 separates frustroconical wedge 190 and frustroconical wedge 195 when inserted into frustroconical bore 165. The gaps allow for radial contraction of each frustroconical wedge toward the other frustroconical wedges toward the wire rope during operation of the invention. Gap 205 is typically ⅜ of an inch. In the preferred embodiment, there are three equally spaced and identical frustroconical wedges. However, in alternate embodiments, there can be two or more frustroconical wedges divided axially to provide compression forces to wire rope 15.

In the preferred embodiment, the angle of inclination of the frustroconical wedges is about 96 degrees plus or minus 5 degrees. Of course, other angles of inclination will function according to engineering choice.

Each of the dimensions of the frustroconical wedges, gaps and slots can differ, depending on the size of the wire rope and the frustroconical bore. Each of the frustroconical wedges are preferably made of mild steel or an aluminum alloy.

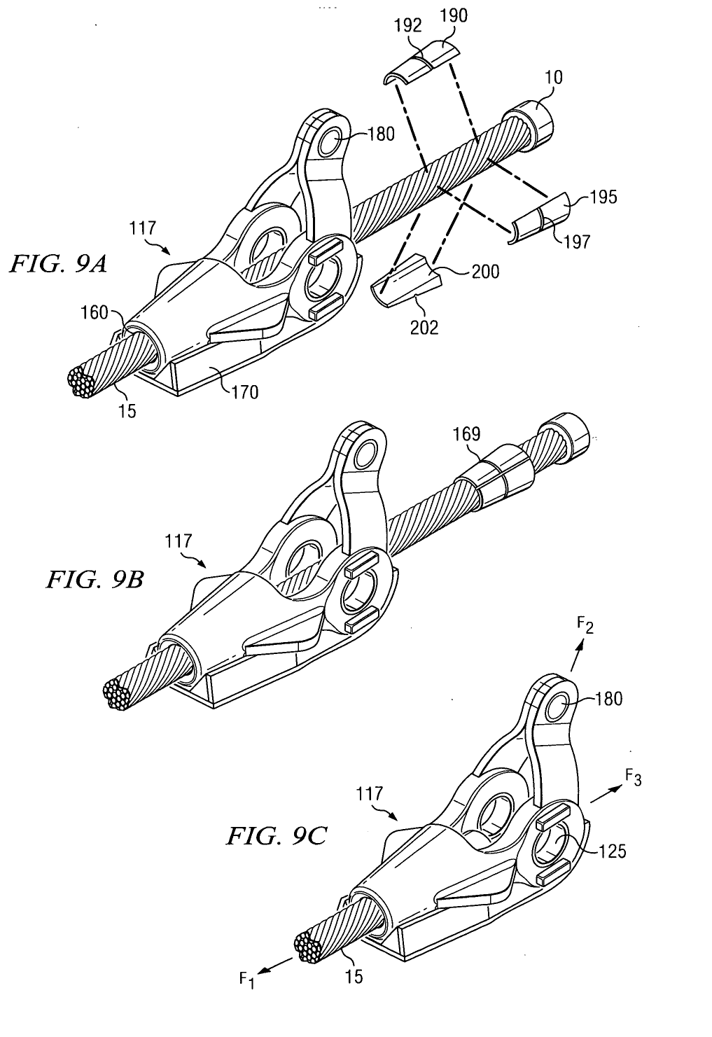

Turning to FIGS. 9a, 9b and 9c, the assembly and usage of the termination, frustroconical wedges and socket can be seen.

FIG. 9 shows an exploded view of socket 117, wire rope 15 and termination 10, as well as frustroconical wedges 190, 195 and 200. In operation, wire rope 15 is threaded through bore 160 in socket 117. Termination 10 is then formed on wire rope 15 as previously described.

Frustroconical wedges 190, 195 and 200 are then assembled onto wire rope 15 as shown in FIG. 9b. A circular retaining tie 169 is then fitted into the surface slots to hold the frustroconical wedges in place on the wire rope. If desired, lubrication is placed in circumferential slots 145, 150 and 155. The wire rope, frustroconical wedges and termination are then pulled into socket 117. The termination seats on mating surfaces 191, 196 and 202 on frustroconical wedges 190, 195 and 200, respectively. In turn, the frustroconical wedges seat inside frustroconical bore 165.

FIG. 9c shows the forces applied to wire rope 15 and socket 117 during operation. Force F1 is applied axially along the wire rope resisted by force F3 applied to through hole 125. A lifting force F2 is then applied to hole 180 resulting in lifting and pulling of mining equipment. Force F2 and F3 are resisted by a combination of the friction on the wire rope resulting from the inward radial pressure of the frustroconical wedges on the wire rope. In turn, the inward radial pressure is created by the force F1 acting through the contact between the termination and the mating surfaces of the frustroconical wedges. As force F1 is increased, the radial pressure on the wire rope is also increased.

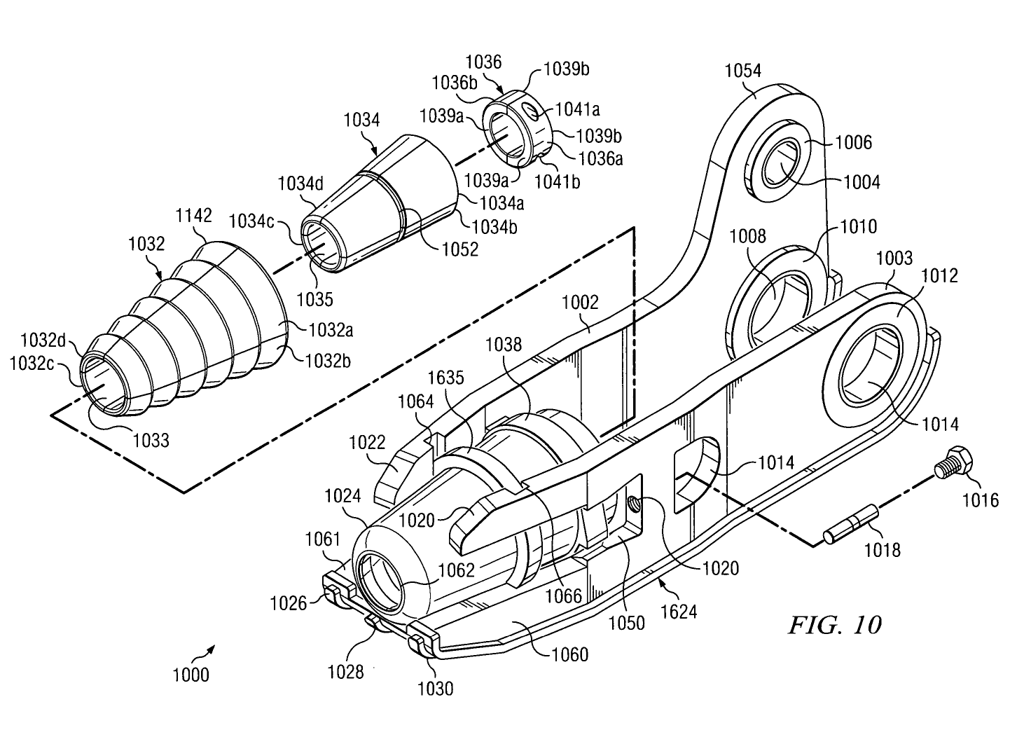

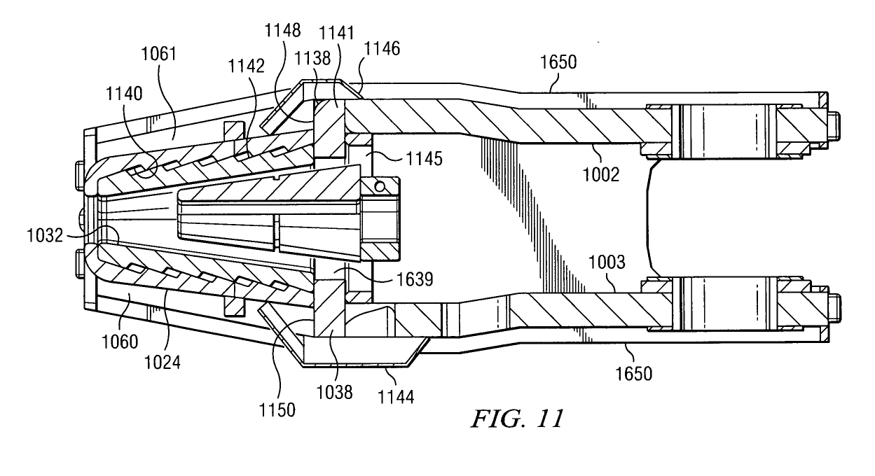

Referring to FIGS. 10 and 11, an alternate embodiment of a drag socket according to the present invention is shown.

Drag socket 1000 includes a socket frame comprised of socket support 1002, socket support 1003 and skid pad 1024. Socket support 1002 and socket support 1003 are high tensile steel and are approximately two inches thick. Each is welded, inside and out to skid pad 1024. Skid pad 1024 is also high tensile steel. Supporting and reinforcing skid pad 1024 from underneath are skid rails 1026, 1028 and 1030. Skid rails 1026, 1028 and 1030 are also formed of high tensile steel. In the preferred embodiment, the skid rails are melded to the bottom of the skid pad.

Socket support 1002 includes offset ear 1054. Offset ear 1054 includes hole 1004 in which is pressed bushing 1006. Socket support 1002 also includes hole 1008 into which is pressed bushing 1010. Socket support 1003 includes hole 1014 into which is pressed bushing 1012.

Upper retaining arms 1020 and 1022 and lower retaining arms 1060 and 1061 are formed in socket support 1002 and socket support 1003, respectively to support socket body 1024. Socket support 1003 also includes access hole 1014 and longitudinal hole 1020.

As can best be seen in FIGS. 10 and 11, socket body 1024 is generally a hollow frustroconical shape having a bore 1062. Interior of bore 1062 includes inwardly facing gradiated serrations 1140. Inwardly facing gradiated serrations of the preferred embodiment can range between 15 and 30 degrees with a preferred range between 17 and 20 degrees in inclination. In the preferred embodiment, socket body 1024 is a high alloy steel. In the preferred embodiment, high tensile 4140 steel is used for socket body 1024.

Within socket body 1024 and adjacent to inwardly facing gradiated serrations 1140 is releasing wedge 1032. Releasing wedge 1032 is generally a frustroconical shape having a bore 1033 and four identical sections 1032a, 1032b, 1032c and 1032d. When assembled, sections include radial outwardly facing gradiated serrations 1142. In the preferred embodiment, the inclination of the outwardly facing gradiated serrations can range between 15 and 30 degrees with a preferred range of between 17 and 20 degrees. Outwardly facing gradiated serrations 1142 are adjacent and engage with inwardly facing gradiated serrations 1140. The sections of releasing wedge 1032a-d are made of a high alloy steel. In the preferred embodiment, the high alloy steel is case hardened 4140. Around the exterior of socket body 1024 a support ring 1035 is welded. Support ring 1035 fits within slot 1064.

Socket body 1024 fits within and is gripped by upper retaining arm 1020, upper retaining arm 1022, lower retaining arm 1060 and lower retaining arm 1061. In an alternate embodiment, the support ring is not present on the socket body and the slots 1064 and 1066 are not present in socket supports 1002 and 1003, respectively. Interior bore 1033 of releasing wedge 1032 is a frustroconical shape having an angle of inclination of about 96 degrees plus or minus 5 degrees.

Within releasing wedge 1032 and adjacent to interior bore 1033 is locking wedge 1034. Locking wedge 1034 forms a generally frustroconical shape having an interior bore 1035. Locking wedge 1034 is comprised of four identical sections 1034a, 1034b, 1034c and 1034d. When assembled, circumferential slot 1052 can be seen to be centrally spaced around the exterior of the frustroconical surface of locking wedge 1034. Interior bore 1035 is cylindrical and sized to fit the selected diameter of the wire rope on which the drag socket is placed. Locking wedge 1034 is a mild steel. In the preferred embodiment, the mild steel is medium carbon 1018 steel. Each of the sections 1034a, 1034b, 1034c and 1034d include a flat surface adjacent to load ring 1036.

Load ring 1036 is generally cylindrical and formed in two pieces 1036a and 1036b. The two pieces are held together by bolts (not shown) through bolt holes 1041a and 1041b. When assembled, load ring 1036 has a flat surface 1039a adjacent locking wedge 1034 and flat surface 1039b adjacent the wire rope termination. In an alternate embodiment, load ring 1036 is not present and the wire rope termination is placed directly against the locking wedge.

As shown best in FIG. 11, socket support 1002 includes a load plate retaining slot 1148. Load plate seat 1150 is formed in socket support 1003. Fitting within load plate retaining slot 1148 and load plate seat 1150, and directly adjacent to the proximal end of socket body 1024 is load plate 1038. Load plate 1038 is generally flat and cylindrical having a load plate bore 1039, a hinge tab 1141, and retaining tab 1050. The load plate includes strengthening cylinder 1145 which is welded to the top surface of the load plate. Hinge tab 1141 fits within load plate retaining slot 1148, retaining tab 1050 fits within load plate seat 1150. Hinge tab 1141 includes a rounded hinge surface 1138. In the preferred embodiment, hinge surface 1138 is a radius of approximately one inch. The rounded hinge surface allows the load plate to be rotated into position in the load plate retaining slot and load plate seat.

Load plate 1038 is maintained in place in the drag socket by pressure exerted on load plate retaining tab 1050 by load shaft 1018. Load shaft 1018 contacts the load plate retaining tab and is aligned with and fits within longitudinal hole 1020. Socket head cap screw 1016 is threaded into longitudinal hole 1020 from the other side and presses load shaft 1018 into contact with load plate retaining tab 1050.

As shown in FIG. 11, cover plate 1144 fits over access hole 1014, longitudinal hole 1020 and load plate seat 1050. Similarly, cover plate 1146 fits over hinge surface 1138.

In operation, drag socket 1000 is connected a mining control line through bushing 1006 and hole 1004. The control line is used to raise or lower the drag socket. A drag line is connected to the drag socket via bushings 1010 and 1012 and holes 1008 and 1014. The drag line is used to pull a dump bucket forward during use.

The socket body is placed over the wire rope connected to the drag bucket through bore 1062. A wire rope termination is formed on the free end of the wire rope (not shown) as previously described. The releasing wedge sections are then placed around the wire rope and fitted into socket body 1024. The locking wedge sections are then placed around the wire rope and held in place by a tie fitted in circumferential slot 1052. A wire rope is also threaded through the bore of load plate 1038. Load ring 1036 is then placed around the wire rope and fastened adjacent the termination. A force is applied to the wire rope bringing the wire termination in contact with the load ring which in turn places a force on locking wedge 1034 and pulls it into releasing wedge 1032 fitted within socket body 1024.

Once the wire rope, termination and socket body are in place, load plate 1038 is fitted within drag socket 1000. Hinge tab 1141 is placed at an angle into load plate retaining slot 1148. Load plate 1038 is rotated such that load plate retaining tab 1050 is placed within load plate seat 1150. Load shaft 1018 is then pushed through longitudinal hole 1020 into contact with retaining tab 1050. Socket head cap screw is then threaded into longitudinal hole 1020 pressing the load shaft into contact with the load plate retaining tab which in turn presses load plate retaining tab 1050 into load plate seat 1150.

In operation, a force is then applied to the wire rope away from the drag socket. In practice, this force can be as high as 1.4 million pounds. The immense force placed on the wire rope is translated to the drag socket via the wire termination and the socket body. In a surprising reaction, the immense tension on the drag socket forces the releasing wedge in a direction away from the tension force on the wire rope with great force. The force tends to push releasing wedge 1032 out of socket body 1024. In operation, the movement of the releasing wedge is resisted and prevented by load plate 1038.

After the useful life of the wire termination has been completed, the load shaft is removed by cutting it generally in half with a torch. It can also be cut with a saw; in the field, a “sawsall” device is preferred. Once removed, load plate 1038 rotates out of the way, releasing the pressure on the releasing wedge which then, in practice, “pops” out of the socket body. Once released, the socket body can be lifted out of the drag socket and the wire termination can be replaced before further use. The advantage realized by the invention will be immediately apparent to those skilled in the art. In prior art drag sockets, the wire rope can only be removed from the drag socket with immense force such as sledge hammers or by physical cutting, resulting in a dangerous condition. The invention allows the wire rope to be disconnected safely with the use of minimum tools.

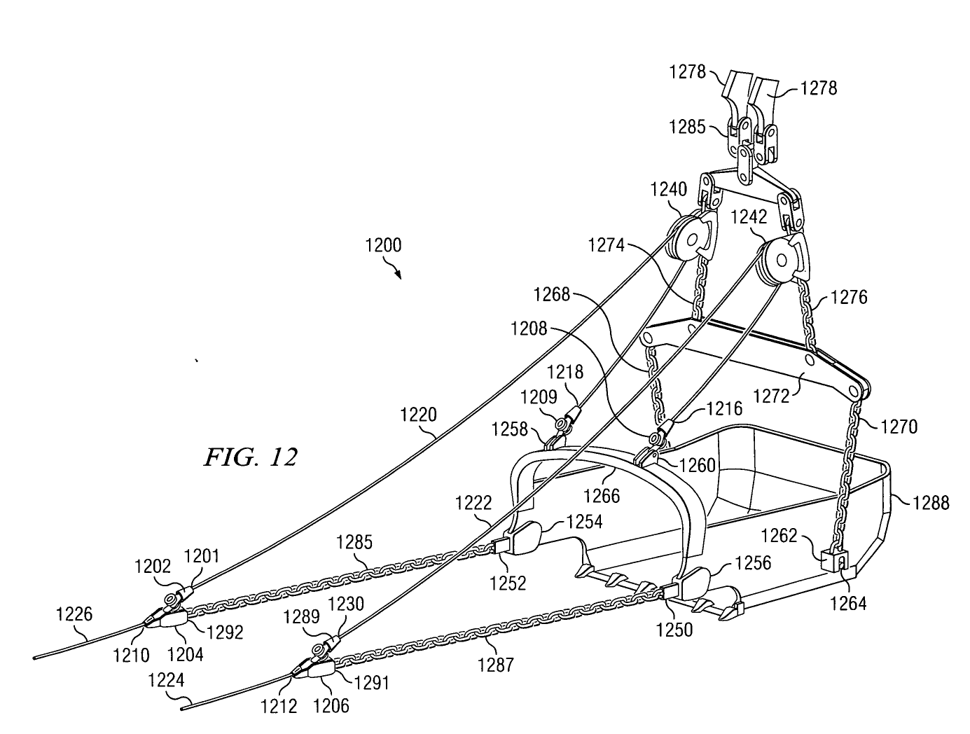

FIG. 12 depicts a mining system 1200 employing the wire rope termination that can be used with excavation equipment of various types, particularly draglines for earth moving mining equipment. The mining system 1200 utilizes wire ropes with a diameter between ¼ inches and 7 inches. The wire rope can be a single or multi-stranded and are made of steels, alloys of steel or combinations thereof.

In the mining system 1200, termination 1201 is disposed on one end of dump rope 1220 as shown. Termination 1201 is engaged with dump rope socket 1202. Dump rope socket 1202 connects to a bucket rigging device thru drag rope socket 1204. Sockets such as those generally shown in FIG. 5 and FIG. 7 or any other sockets known to be compatible in the art may be used as a dump rope socket or a drag rope socket.

Referring to the socket of FIG. 7 as an example, drag rope socket 1204 has ears 118 and bushing 185 with a hole 180. The sockets are connected in operation by aligning the ears of the dump rope sockets 1202 with the hole of the bushing of the drag rope socket 1204. When the three holes are aligned, a throughpin is inserted to connect the ears of the dump rope socket 1202 to the upper hole in the bushing of the drag rope socket.

Referring to FIG. 12, Drag rope socket 1204 is connected to drag rope 1226 with a termination 1210. A drag rope link 1292 connected to drag rope socket 1204 links the socket to drag chain 1285. On the other end of drag chain 1285, drag hitch link 1252 connects chain 1285 to drag hitch 1254. Drag hitch 1254 is mounted to mining bucket 1288.

A mirror opposite of the above is also depicted in FIG. 12. Termination 1230 is disposed on one end of dump rope 1222. Termination 1230 is engaged with dump rope socket 1289. Dump rope socket 1289 connects to a bucket rigging device thru drag rope socket 1206. Similarly, dump rope socket 1289 connects to drag rope socket 1206 by aligning the ears of the dump rope socket 1289 to the bushings of drag rope socket 1206.

Drag rope socket 1206 is connected to drag rope 1224 with a termination 1212. A drag rope link 1291 connected to drag rope socket 1206 links the socket to the drag chain 1287. On the other end of drag chain 1287, a drag hitch link 1250 connects chain 1287 to hitch 1256. Drag hitch 1256 is mounted to mining bucket 1288.

Dump ropes 1220 and 1222 also have terminations 1218 and 1216 engaged with arch anchor sockets 1209 and 1208. Arch anchor sockets 1209 and 1208 are connected to arch anchors 1258 and 1260. Arch anchors 1258 and 1260 are mounted on arch 1266. Arch 1266 is attached to the upper outside corners of mining bucket 1288. In a preferred embodiment, arch 1260 is welded to mining bucket 1288.

Attached to mining bucket 1288 is a trunion 1262. Trunion 1262 has a trunion pin 1264 inserted in the trunion 1262 which allows for rotation of mining bucket 1288. A second trunion and trunion pin are located on the opposite side of mining bucket 1288. Trunion 1262 connects to lower hoist chain 1270. Similarly lower hoist chain 1268 is connected to a trunion on the opposite side of mining bucket 1288. Lower hoist chains 1268 and 1270 are connected to spreader bar 1272. Also connected to spreader bar 1272 are upper hoist chains 1274 and 1276. Mounted on upper hoist chains 1274 and 1276 are dump sheaves 1240 and 1242.

Dump sheaves 1240 and 1242 are pulleys through which the dump ropes 1220 and 1222 are threaded. Connected at the other ends of the upper hoist chains 1274 and 1276 is a hoist rigging cluster 1285. Hoist rigging cluster 1285 may vary significantly in design. Hoist ropes are freely connected to hoist rigging cluster 1278. Hoist ropes 1278 typically connect to a crane used in the operation of the mining system.

In exemplary embodiments, the mining bucket is used for dirt or ore. In the preferred embodiment, the mining system is suspended from a crane by the hoist ropes 1078. In operation of the mining system, the mining bucket is lowered near or set on the surface to be mined. The crane exerts a pulling force on the drag ropes which in turn pull the drag chains and the mining bucket. This process sets out to cause dirt or ore or any other materials to be collected from the surface. Once the mining bucket has collected the substances to be mined, an upward force is exerted by the crane at the hoist ropes which elevates the rear portion of the mining bucket. Simultaneously, a pulling force is exerted on the drag ropes. As the tension on the drag rope increases, the tension in the dump rope will increase resulting in the elevation of the front of the mining bucket. By increasing the elevation of the front, the collected substances are trapped in the mining bucket.

The mining bucket is dumped out by decreasing the force on the drag ropes which causes the tension in the dump ropes to decrease. This process subsequently lowers the front of the mining bucket and releases the contents of the bucket. The mining bucket is returned to its original mining position by releasing the tension in the hoist ropes and drag ropes.

The embodiments have been described in detail with particular reference to certain preferred embodiments thereof, but it will be understood that variations and modifications can be effected within the scope of the embodiments, especially to those skilled in the art.

1. A excavation mining drag socket for connection to a steel excavation drag rope comprising:
a frame;
a first attachment means for connecting the frame to an excavation mining dump bucket control line;
a second attachment means for connecting the frame to an excavation mining drag chain;
a socket body removably attached to the frame;
a releasing wedge releasably inserted into the socket body;
a locking wedge set having a cylindrical bore, releasably inserted into the releasing wedge;
a wire rope termination integrally fused to an end of the excavation drag rope adjacent the locking wedge;
the excavation drag rope releasably secured within the cylindrical bore; and
a load plate movably attached to the frame adjacent the releasing wedge whereby the releasing wedge is retained in the socket body when a force is applied to the excavation drag rope.

2. The excavation mining drag socket of claim 1 further comprising a load shaft adjacent the load plate and the frame for removably securing the load plate within the frame.

3. The excavation mining drag socket of claim 1 further comprising a retaining means, attached to the frame and adjacent the load plate for securing the load plate within the frame.

4. The excavation mining drag socket of claim 1 wherein the socket body includes a set of inwardly facing serrations.

5. The excavation mining drag socket of claim 4 where in the inwardly facing serrations are formed at an angle between 15° and 30°.

6. The excavation mining drag socket of claim 4 where in the inwardly facing serrations are formed at an angle between 17° and 20°.

7. The excavation mining drag socket of claim 1 wherein the releasing wedge includes a set of outwardly facing serrations.

8. The excavation mining drag socket of claim 7 where in the outwardly facing serrations are formed at an angle between 15° and 300.

9. The excavation mining drag socket of claim 7 where in the outwardly facing serrations are formed at an angle between 17° and 20°.

10. The excavation mining drag socket of claim 1 wherein the socket body is frustroconical.

11. The excavation mining drag socket of claim 1 wherein the releasing wedge is frustroconical.

12. The excavation mining drag socket of claim 1 wherein the locking wedge set, when assembled is frustroconical.

13. The excavation mining drag socket of claim 1 the socket body further comprises a set of inward facing graduated serrations engaging an outwardly facing set of graduated serrations on the releasing wedge.

14. The excavation mining drag socket of claim 1 wherein the locking wedge is comprised of a deformable material.

15. The excavation mining drag socket of claim 1 wherein the wire rope termination is comprised of a solidified molten material internally welded to the wire rope as it is cooled.

16. The excavation mining drag socket of claim 1 wherein the wire rope termination is comprised of a solidified adhesive material.

17. The excavation mining drag socket of claim 1 wherein the frame further comprises a pair of upper retaining arms and a set of lower retaining arms adjacent the socket body.

18. The excavation mining drag socket of claim 1 wherein the frame further comprises an offset connection ear.

19. A process of forming a drag socket attached to a wire rope for use with an excavation mining drag bucket comprising:
providing a drag socket frame;
inserting the wire rope into a socket body in the drag socket frame;
forming a termination on the wire rope;
applying a releasing wedge to the wire rope and placing it into the socket body;
applying a locking wedge to the wire rope and placing it into the releasing wedge;
applying a load plate adjacent the socket body in a position to resist forces from the releasing wedge; and
applying tension to the wire rope to move the termination to compress the locking wedge and the releasing wedge.

20. The method of claim 19 wherein forming a termination further comprises:
providing a mold with a mold opening and a mold cavity;
inserting a wire rope into the mold opening;
flowing a liquefied material into the mold cavity; and
allowing the liquefied material to harden thereby creating a solid termination joined to the wire rope.

21. The method of claim 20 wherein flowing a liquefied material into a mold cavity includes placing a crucible in ducted communication with the mold cavity and melting a metal alloy in the crucible.

22. The method of claim 2 wherein melting the metal alloy in a crucible includes melting the metal alloy with an oxidation reaction.

23. The method of claim 2 wherein melting a metal alloy in the crucible includes filing the crucible with a metallic powder and igniting it with a high temperature flame.

24. The method of claim 20 wherein forming a liquefied material includes igniting a thermite reaction to provide the liquefied material.

25. The method of claim 24 wherein igniting the thermite reaction includes igniting the reaction 3Fe₃O₄+8Al=9Fe+4Al₂O₃.

26. The method of claim 24 wherein igniting the thermite reaction includes igniting the reaction 3FeO+2Al=3Fe+Al₂O₃.

27. The method of claim 24 wherein igniting the thermite reaction includes igniting the reaction Fe₂O₃+2Al=2Fe+Al₂O₃.

28. The method of claim 24 wherein igniting the thermite reaction includes igniting the reaction 3CuO+2Al=3Cu+Al₂O₃.

29. The method of claim 24 wherein igniting the thermite reaction includes igniting the reaction 3Cu₂O+2Al=6Cu+Al₂O₃.

30. The method of claim 20 further including:
providing a crucible held in ducted communication with the mold cavity;
adding a metallic powder to the crucible; and
reducing the powder to the liquefied material.

31. A process of releasing a drag socket from a dump bucket dragline comprising:
providing a drag socket frame;
providing a termination on the dump bucket dragline;
providing a locking wedge adjacent the termination;
providing a releasing wedge around the locking wedge;
providing a socket body, secured in the socket frame around the releasing wedge;
providing a load plate adjacent the releasing wedge and removably secured within the frame;
providing a retaining means for applying pressure to the load plate and the frame; and
removing the retaining means whereby pressure on the load plate is released and the releasing wedge is released.

32. The process of claim 31 including providing a load ring between the termination and the locking wedge.

33. The process of claim 31 wherein removing includes cutting the retaining means.

34. A method for joining a solid termination on a wire rope to a wire rope and drag socket comprising:
providing a mold with a mold opening and a mold cavity;
inserting a wire rope into the mold opening;
flowing a liquefied material into the mold cavity;
allowing the liquefied material to harden thereby creating the solid termination having a generally flat concentric thrust exerting surface generally perpendicular to a longitudinal axis of the wire rope and joined to the wire rope;
removably affixing a plurality of axially aligned frustroconical sections to the wire rope;
providing a flat thrust receiving surface on each frustroconical section at an approximate right angle to the longitudinal axis of the wire rope;
abutting the flat concentric thrust exerting surface against the flat thrust receiving surface of each frustroconical section; and
inserting the plurality of axially aligned frustroconical sections into a frustroconical receiver in the drag socket.

35. The method of claim 34 wherein flowing a liquefied material includes reducing a powdered metal oxide to a metal.

36. The method of claim 35 wherein reducing further comprises reducing one of a copper oxide, an iron oxide and an aluminum oxide.

37. The method of claim 34 wherein forming a liquefied material comprises providing a crucible held in ducted communication with the mold cavity.

38. The method of claim 34 wherein flowing a liquefied material includes producing a liquefied material through a thermite reaction.

39. The method of claim 34 including:
providing a crucible held in ducted communication with the mold cavity;
adding a metallic powder to the crucible; and
reducing the powder to the liquefied material.

40. The method of claim 34 wherein flowing a liquefied material includes flowing an adhesive epoxy.

41. The method of claim 34 wherein flowing a liquefied material includes igniting a thermite reaction with a metal powder.

42. An apparatus for connecting a drag line to a drag chain comprising:
a drag line termination means, fused to the end of the drag line for rigidly expanding the diameter of the drag line;
a connector frame attached to the drag chain and to a lift line; and
a receiver means within the connector frame, abutting the drag line termination means, for compressing the drag line termination means to resist a force applied to the drag line.

43. The apparatus of claim 42 wherein the receiver means includes a generally frustroconical bore formed internally with the connector frame and the drag line termination means includes a generally frustroconical exterior surface adjacent the generally frustroconical bore.

44. The apparatus of claim 42 wherein the receiver means includes:
a socket body removably attached to the connector frame;
a releasing wedge releasably inserted into the socket body;
a locking wedge releasably inserted into the releasing wedge; and
a load plate movably attached to the connector frame adjacent the releasing wedge
wherein the releasing wedge is retained in the socket body when a force is placed on the drag chain.

45. The apparatus of claim 42 wherein the receiver means includes a plurality of frustroconical wedges adhered to the surface of the drag line adjacent the drag line termination means.

46. The apparatus of claim 45 wherein the connector frame further includes a stiffening means, integrally formed with the exterior of the connector frame for resisting expansion of the receiver means when a force is placed on the drag line.

47. The apparatus of claim 42 wherein the receiver means further includes a release means removably attached to the connector frame for maintaining the position of the receiver means within the connector body when a force is placed on the drag chain.

48. The apparatus of claim 42 wherein the drag line termination means is fused to the end of the drag line with a thermite reaction.

49. A coupler for connecting a drag rope termination on a wire mining excavation drag rope, a mining excavation dump rope and a mining excavation drag chain for use with a drag mining bucket comprising:
a drag rope termination, formed from a solidified molten metal, welded to and completely surrounding an end of the wire mining excavation drag rope;
a base sled having a central longitudinal axis and having downwardly facing longitudinal sled protrusions;
a first vertical support wall rigidly attached to the base sled;
the first vertical wall including a first chain retaining pin hole perpendicular to the longitudinal axis of the base sled;
the first vertical wall further comprising a threaded access hole in ducted communication with a longitudinal through hole adjacent a first vertical channel;
the first vertical wall further comprising a first upper retaining arm angled toward the central longitudinal axis of the base sled and a first lower retaining arm angled toward the central longitudinal axis of the base sled;
a second vertical retaining wall rigidly attached to the base sled;
the second vertical wall including a second chain retaining pin hole perpendicular to the longitudinal axis of the base sled and a second vertical channel opposite the first vertical channel;
the second vertical wall including a dump rope retaining pin hole perpendicular to the central longitudinal axis of the base sled;
the second vertical wall further comprising a second upper retaining arm angled toward the central longitudinal axis of the base sled and a second lower retaining arm angled toward the central longitudinal axis of the base sled;
the first vertical wall and second vertical wall forming a longitudinal channel with respect to the base sled;
a frustroconical socket body having a first internal bore and a first external surface, having a rearward facing edge, having a forward biased set of concentric striations on the first internal bore and a having the external surface adjacent the first and second upper retaining arms and the first and second lower retaining arms and being seated in the longitudinal channel;
a frustroconical releasing wedge having a second internal bore and a second outside surface, having a rearward biased set of concentric striations on the second external surface in contact with the forward biased set of concentric striations;
a set of frustroconical locking wedges, when assembled having a cylindrical internal bore and a third external surface, the third external surface in contact with the second internal surface, the cylindrical internal surface in contact with the exterior surface of the wire mining excavation drag rope;
the set of frustroconical locking wedges when assembled having a generally flat thrust surface perpendicular to the central longitudinal axis of the base sled;
a cylindrical load plate, having a forward flat surface, a rearward flat surface and a first access hole surrounding the wire mining excavation drag rope;
the forward flat surface adjacent the rearward facing edge of the frustroconical socket body;
the rearward flat surface further comprising a cylindrical retaining ring having a second access hole surrounding the wire mining excavation drag rope;
the cylindrical load plate positioned in the longitudinal channel and in the first vertical channel and the second vertical channel;
the cylindrical load plate retained in the first and second vertical channels by a sacrificial load pin positioned in the longitudinal through hole;
the sacrificial load pin retained in the longitudinal through hole by a threaded bolt in the threaded access hole;
a load ring fitted around the wire mining excavation drag rope adjacent the generally flat thrust surface, adjacent the second access hole and adjacent the drag rope termination;
the mining excavation drag chain operationally connected to the first chain retaining pin hole and the second chain retaining pin hole; and
the mining excavation dump rope operationally connected to the dump rope retaining pin hole.

50. The coupler of claim 49 wherein the forward biased set of concentric striations are formed at an angle of between about 15° and about 30°.

51. The coupler of claim 49 wherein the forward biased set of concentric striations are formed at an angle of between about 17° and about 20°.

52. The coupler of claim 49 wherein the rearward biased set of concentric striations are formed at an angle of between about 15° and about 30°.

53. The coupler of claim 49 wherein the rearward biased set of concentric striations are formed at an angle of between about 17° and about 20°.
